(19) United States
(12) Patent Application Publication
(10) Pub. No.: US 2008/0100003 A1
(43) Pub. Date: May 1, 2008

(54) BIASED WALL SEALS FOR EXTENSION UNIT

(76) Inventor: Dennis R Vance, Edwardsburg, MI (US)

Correspondence Address: BAKER & DANIELS LLP, 300 NORTH MERIDIAN STREET, SUITE 2700, INDIANAPOLIS, IN, 46204, US

(21) Appl. No.: 11/554,418

(22) Filed: Oct. 30, 2006

(51) Int. Cl. F16J 15/32

(52) U.S. Cl. 277/553

(57) ABSTRACT

The present invention involves a sealing member assembly used as a fluid and debris barrier for use in association with the extendable walls of an extension unit for a structure. The sealing member assembly includes a frame attached to the structure, a sealing member slideably coupled to the frame and bearing against the extendable walls of the structure, and a biasing member biasing the sealing member away from the frame and against the extendable walls.

### BACKGROUND OF THE INVENTION

1. Field of Invention

The present invention relates generally to slide-out rooms or movable extension units for creating additional interior living space within a structure. More particularly, the present invention relates to a seal assembly for use with such slide-out rooms and movable extension units.

2. Background Art

The interior living space provided by structures, such as recreational vehicles (RV), manufactured housing units, trailer components and campers, is limited by many factors. For instance, the interior living space of such a structure is restricted in its dimensions to the width of the roads and highways upon which the structure is transported. The interior space of such a structure may also be limited to the storage unit or garage in which the structure is stored when not in use. Once the structure reaches its destination, however, these space-limiting factors are no longer an issue and the occupants typically prefer to have greater amounts of interior living space.

To accommodate the desire for additional interior space in the above-described structures, these structures have been equipped with expandable compartments formed by an extension unit. Extension units include expandable walls that retract and extend from non-extendable or stationary walls of the structure.

As illustrated in FIG. 2, conventional static seals 34 are mounted between the non-extendable walls 12 and the extendable walls 16 to prevent unwanted fluids and debris from entering the interior space. For static seal 34, the distance between non-extendable wall 12 and extendable wall 16 compared to the length of static seal 34 determines the amount of compressive force placed by extendable wall 16 on static seal 34. The rate at which static seal 34 abrades increases as the distance between non-extendable wall 12 and extendable wall 16 becomes progressively shorter than the length of static seal 34.

Translation of extendable walls 16 in either direction of the double-headed arrow applies a force against static seals, which degrades the effectiveness of static seal 34. When the surface of extendable wall 16 is not parallel to the edge of non-extendable walls 12 during translation, static seal 34 is subjected to uneven compressive force which leads to uneven abrading and reduced seal efficiency. Furthermore, creating an effective seal in the corner of two extendable walls is challenging and the corner may create a point of high compressive force that may cause a static seal 34 to quickly abrade in the area of the corner.

### SUMMARY OF THE INVENTION

The present invention provides a sealing member assembly for use in biasing a seal between the extendable walls of an extension unit and the non-extendable walls of the structure in which the extension unit is installed. The sealing member assembly is spring-biased against the extendable walls of extension unit.

In one aspect, the present invention provides a sealing member assembly for creating a seal between an extendable wall of an extension unit of a structure and a non-extendable wall of the structure. The sealing member includes a frame configured to attach to the non-extendable wall of the structure, a first sealing member moveably coupled to the frame and a biasing element biasing the first sealing member away from the frame and toward the extendable wall.

In another form, the sealing member assembly includes a frame configured to be coupled to the non-extendable wall of the structure, a sealing member coupled to the frame, a brush wiper seal coupled to the sealing member and a polymer member coupled to the sealing member. The brush wiper and the polymer member are adapted to bear against the extendable walls.

In yet another form, the present invention provides a seal assembly for use with a structure. The structure has an opening receiving an extension unit. The extension unit is formed by a plurality of extendable walls. The opening of the structure is defined by at least one horizontal non-extendable wall and at least one vertical non-extendable wall. One of the horizontal non-extendable walls and one of the vertical extendable walls intersect to form a corner of the opening. The seal assembly includes a pair of vertical sealing members adapted to be coupled to one of the vertical non-extendable walls. Each of the pair of vertical sealing members has an end positioned proximal to the corner. A pair of horizontal sealing members are adapted to be coupled to one of the horizontal non-extendable walls. Each of the pair of horizontal sealing members has an end positioned proximal to the corner. One of the pair of horizontal sealing members extends over the end of one of the pair of vertical sealing members and the other of the pair of vertical sealing members extends over the end of the other of the pair of horizontal sealing members to provide overlapping sealing at the corner.

### BRIEF DESCRIPTION OF THE DRAWINGS

The embodiments disclosed below are not intended to be exhaustive or limit the invention to the precise forms disclosed in the following detailed description. Rather, the embodiments are chosen to describe so that others skilled in the art may utilize their teachings.

FIG. 1 is a perspective view of a structure having an extension unit shown in the expanded (deployed) position;

FIG. 2 is a sectional view of a static seal of the prior art;

FIG. 3 is a sectional view taken along line 3-3 of FIG. 1 and illustrating a sealing member assembly according to one embodiment of the present invention;

FIG. 3A is an enlarged view of the encircled region of FIG. 3;

FIG. 4 is a sectional view of a sealing member assembly according to another embodiment of the present invention;

FIG. 4A is an enlarged view of the corresponding encircled area of FIG. 4;

FIG. 4B is an enlarged view of the corresponding encircled area of FIG. 4;

FIG. 5 is a perspective view in partial cross-section of a sealing member assembly according to yet another embodiment of the present invention;

FIG. 6 is a sectional view of a sealing member assembly taken in the corner region of an extension unit according to another embodiment of the present invention;

FIG. 7 is a perspective view of a structure having an extension unit that is misaligned relative to the structure;

FIG. 7A is an enlarged view of the encircled region of FIG. 7;

FIG. 8 is a perspective view of a structure showing the biasing members of a sealing member assembly of the present invention, spaced along the extension unit;

FIG. 8A is an enlarged view of the encircled region of FIG. 8, wherein the extension unit is aligned relative to the structure; and

FIG. 8B is an enlarged view of the encircled region of FIG. 8 wherein the extension is misaligned relative to the structure.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form thereof, and such exemplifications are not to be construed as limiting the scope of the invention in any manner.

### DESCRIPTION OF THE EMBODIMENTS OF THE INVENTION

The embodiments disclosed below are not intended to be exhaustive or limit the invention to the precise forms disclosed in the following detailed description. Rather, the embodiments are chosen and described so that others skilled in the art may utilize their teachings.

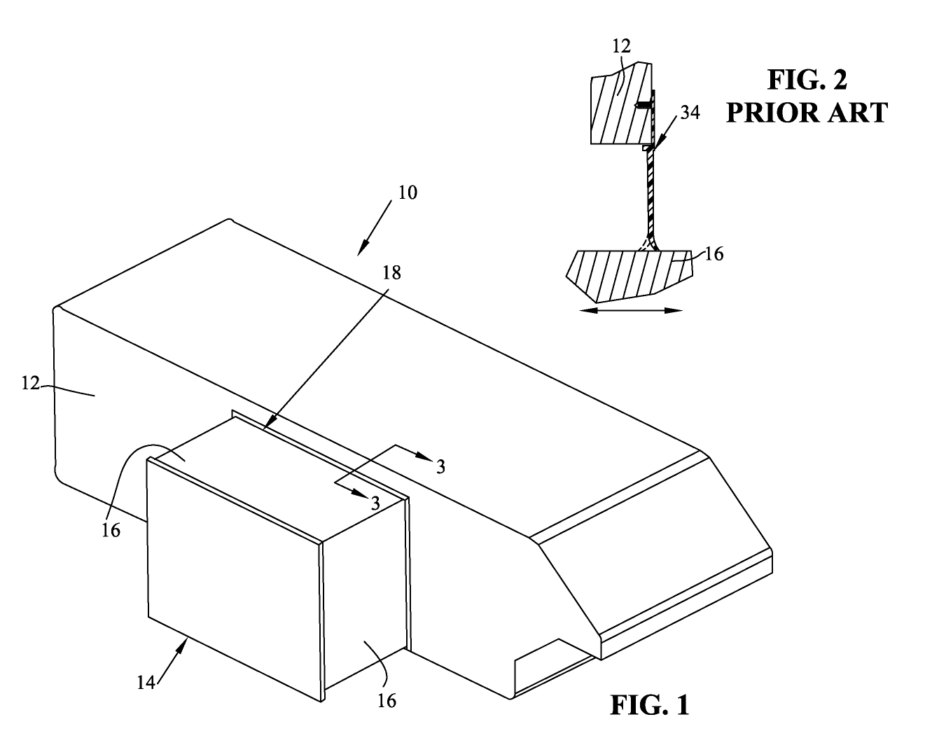

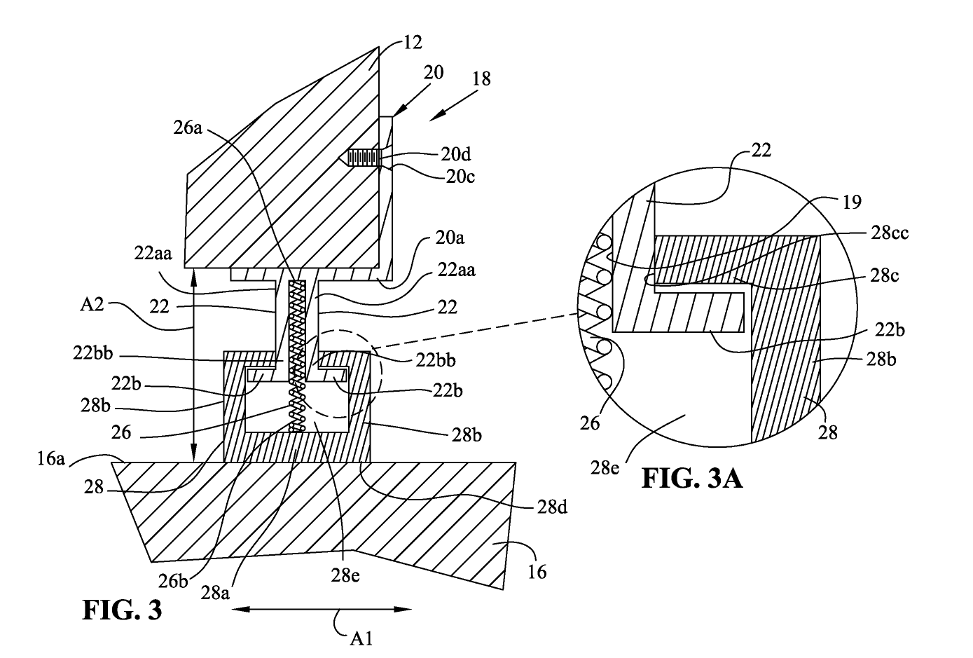

Referring first to FIG. 1, structure 10 having extension unit 14 is illustrated. Structure 10 may be any structure that may benefit from an extendable interior space including, for example, a recreational vehicle, a fifth wheel, camper, trailer, mobile housing or other mobile living, working or storage quarters. Structure 10 generally includes stationary or non-extendable wall 12 and extension unit 14, which cooperate to form an interior space (not shown). Extension unit 14 includes extendable walls 16, which are extendable from walls 12 and translate relative to walls 16. Structure 10 also includes sealing member assembly 18 attached to non-extendable wall 12, extending about extension unit 14 and forming a seal between wall 12 and walls 16.

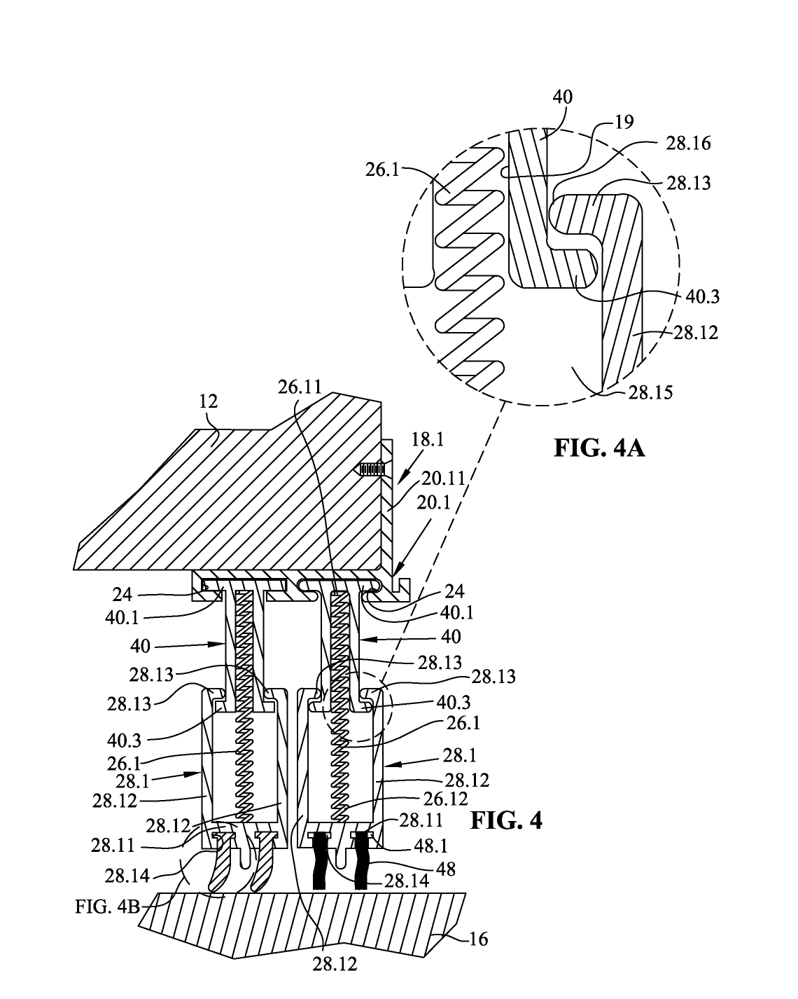

Sealing member assembly 18 is illustrated in further detail in FIGS. 3 and 3A. Sealing member assembly 18 generally includes frame 20, sealing member 28 slidably coupled to frame 20 and biasing element 26 biasing sealing member 28 relative to frame 20. Frame 20 includes body 20A, which in this exemplary embodiment is L-shaped but may be any shape adapted to connect to wall 12. Frame 20 also includes a pair of flanges 22 extending from body 20A. Body 20A is configured to attach to wall 12 and in the illustrated embodiment includes fastener receiving aperture 20C extending therethrough (although body 20A could attach to wall 12 by other mechanisms, such as nails or glue that would not include an aperture. Sealing member assembly 18 is fastened to non-extendable wall 12 of structure 10 by inserting fastener 20D through aperture 20C and into non-extendable wall 12. It is also envisioned that body 20A may be fastened to non-extendable wall 12 using any known fastening devices including, but not limited to, adhesive, nails, screws, and other fastener mechanisms. Each of flanges 22 is coupled at one end 22AA to body 20A and includes lip or rim portion 22B extending perpendicularly outward from opposite end 22BB. Flanges 22 are spaced apart from one another to form channel 19 therebetween.

Sealing member 28 has a substantially C-shaped cross section and includes base portion 28A, pair of spaced apart beam portions 28B extending from base portion 28A and pair of lips or finger portions 28C extending inwardly from beam portion 28B. Base 28A defines sealing surface 28D, which is configured to contact surface 16a of wall 16, as is described in further detail below. Base portion 28A, beam portions 28B and finger portions 28C cooperate with one another to define chamber 28E. Finger portions 28C are spaced from one another to define opening 28CC, which is in communication with chamber 28E and through which flanges 22 slidably extend. Rim portions 22B are disposed within chamber 28E and cooperate with corresponding finger portions 28C to secure sealing member to frame 20 and to limit the sliding movement of flanges 22 in opening 28CC.

Biasing element 26 is at least partially disposed within channel 19 and includes frame-bias end 26A and member-bias end 26B. Frame-bias end 26A is either coupled to or bears against frame 20, while member-bias end 26B is either coupled to or bears against sealing member 28. Biasing element 26 is adapted to bias sealing member 28 away from non-extendable wall 12 and against wall 16. Biasing element 26 is illustrated in FIGS. 3 and 3A as being a spring. However, it should be understood that any mechanism capable of biasing sealing member 28 toward and against wall 16 may be used. For instance, sealing member assembly 18 could function as a hydraulic spring wherein chamber 28E and channel 19 may be filled with liquid capable of creating the biasing force or a pneumatic spring wherein chamber 28E and channel 19 may be filled with compressed gas capable of creating the biasing force. Alternatively, any form of spring or component having spring-like capabilities, such as foam, may serve the biasing function. In yet another alternative, sealing member 28 of the portion of sealing member assembly 18 that extends along the upper portion of extension unit 14 may be weighted such that the force of gravity pulls sealing member toward and against wall 16.

In operation, as extension unit 14 (FIG. 1) is retracted and extended, wall 16 moves in the direction of arrow A₁. As wall 16 moves in the direction of arrow A₁, biasing element 26 biases sealing member 28 and, therefore, sealing surface 28D, against extendable wall 16 to create a seal between extension unit 14 and wall 12. In the event extension unit 14 becomes misaligned, or wall 16 moves upward in the direction of arrow A₂, the force of this movement may overcome the force of biasing element 26 causing sealing member 28 to slide upward along flanges 22 in direction of arrow A₂. Even in this case of misalignment, biasing element 26 continues to bias sealing surface 28D against wall 16, thereby maintaining the seal between extension unit 14 and wall 12. When alignment is restored, biasing element 26 forces sealing member 28 to slide downward along flanges 22 in the direction of arrow A₂, thereby maintaining the seal between extension unit 14 and wall 12.

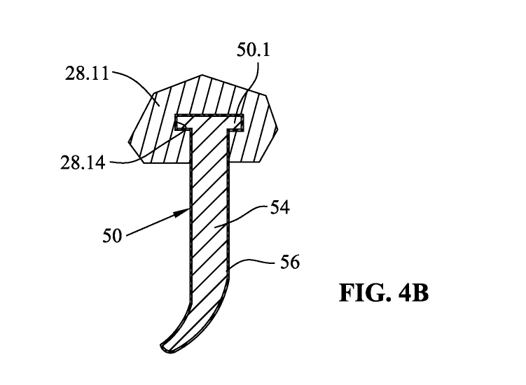

The embodiment of FIGS. 3 and 3A shows sealing member assembly 18 as having only a single pair of flanges 22 that are formed as an integral part of frame 20 such that frame 20 and flanges 22 form a single unit. Alternatively, the sealing member assembly may include any number of flanges, and the flanges may be formed separately from and assembled to the frame. For instance, as shown in FIGS. 4 and 4A, sealing member assembly 18.1 includes frame 20.1, biasing element 26.1, two pair of flanges 40 and sealing member 28.1. Frame 20.1 includes L-shaped body 20.11 configured to be mounted to wall 12 as described above. Frame body 20.11 includes a pair of T-shaped grooves or slits 24 extending along the length of body 20.11. Each pair of flanges 40 includes connector portion 40.1 at one end and rim 40.3 extending perpendicularly from the opposite end. Connector portion 40.1 is configured to be and is received within slit 24 to thereby couple flanges 40 to frame 20.1. Slits 24 and mating connector portion 40.1 may have any complementary shape to allow connector portion 40.1 to mate with slit 24. For instance, slits 24 and connector portion 40.1 may have a keyhole, dove-tail, rounded or rectangular shape.

Flanges 40 are spaced apart from one another to form channel 19.1 therebetween. Biasing element 26.1 is at least partially disposed within channel 19.1 and includes connector-bias end 26.11 and member-bias end 26.12. Connector-bias end 26.11 is either coupled to or bears against connector portion 40.1, while member-bias end 26.12 is either coupled to or bears against sealing member 28.1.

As illustrated in FIGS. 4 and 4A, sealing member 28.1 includes base portion 28.11, pair of spaced apart beam portions 28.12 extending from base portion 28.11, pair of finger portions 28.13 extending perpendicularly inwardly from beam portion 28.12 and seals (in the form of polymer member 50 or brush wiper 48) coupled to and extending from base portion 28.11. Base portion 28.11, beam portions 28.12 and finger portions 28.13 cooperate with one another to define chamber 28.15. Finger portions 28.13 are spaced-apart from one another to define opening 28.16, which is in communication with chamber 28.15 and through which flanges 40 slidably extend. Similar to the embodiment of FIGS. 3 and 3A, rim portions 40.3 are disposed within chamber 28.15 and cooperate with corresponding finger portions 28.13 to secure sealing member 28.1 to flanges 40 and to limit the sliding movement of flanges 40 in opening 28.16, as shown in FIGS. 4 and 4A.

Referring to FIGS. 4 and 4A-4B, base portion 28.11 defines T-shaped slots 28.14 extending along the bottom surface of base portion 28.11. As illustrated in FIGS. 4 and 4B, seals in the form of polymer member 50 and/or brush wiper 48 are coupled to slots 28.14. More particularly, polymer member 50 and brush wiper 48 include T-shaped attachment portions 50.1, 48.1, respectively, at one end. Attachment portion 50.1, 48.1 are received within slots 28.14 to couple polymer member 50 and brush wiper 48 to base portion 28.11. The ends of polymer members 50 and/or brush wipers 48 opposite respective attachment portion 50.1, 48.1 are configured to contact the surface of extendable wall 16. Polymer member 50 may be formed of any suitably resilient material including, for example, rubber, vinyl, plastic or other polymer. In addition, polymer member 50 may be formed of multiple polymer layers. For instance, polymer member 50 may include polymer foam interior 54 and polymer coating layer 56 (e.g., vinyl), as shown in FIG. 4B. Brush wipers 48 are formed of a bundle of fibers. Such fibers may be formed of any material capable of forming such fibers including, synthetic (plastic, nylon, polyester) and non-synthetic fibers.

Sealing member assembly 18.1 operates in a manner similar to sealing member assembly 18 (FIG. 3) described above. In operation, as the extendable wall 16 moves in the direction of arrow A₁, biasing element 26.1 biases sealing member 28.1 and, therefore, polymer members 50 and/or brush wipers 48 against extendable wall 16 (FIG. 4) to create a seal between the extension unit and the non-extendable wall.

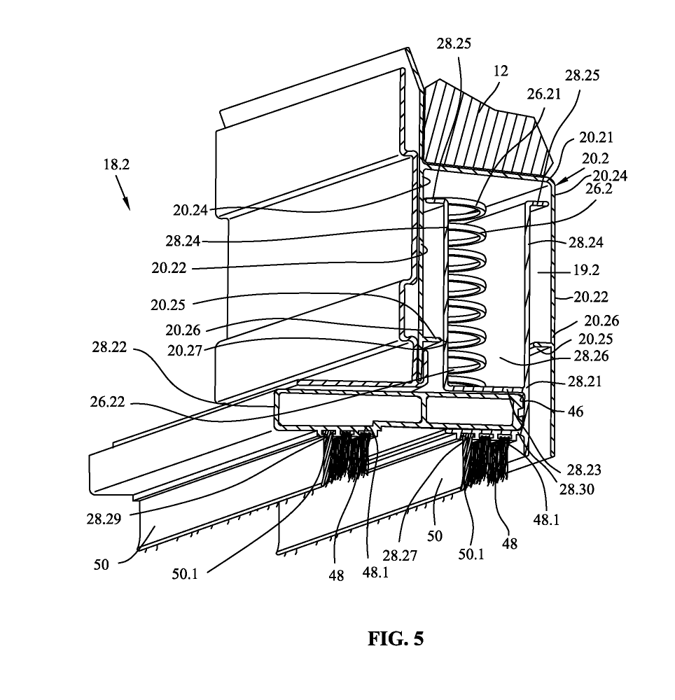

In the embodiments described above, the flanges of the frame are slidably received within the sealing member. The sealing member may be slidably coupled to the frame in any manner. For instance, as illustrated in FIG. 5, the sealing member may be slidably received in the channel between the flanges. More specifically, as shown in FIG. 5, sealing member assembly 18.2 includes frame 20.2, biasing element 26.2 and pair of sealing members 28.21 and 28.22. Frame 20.2 includes body 20.21 and a pair of flanges 20.22 extending from body 20.21. Body 20.21 is configured to be mounted to non-extendable wall 12 in a manner similar to that described above. Each of flanges 20.22 is coupled at one end 20.24 to body 20.21 and includes lip or rim portion 20.25 extending perpendicularly inward from opposite end 20.26. Flanges 20.22 are spaced apart from one another to form channel 19.2 therebetween. Rim portions 20.25 are spaced apart from one another to define opening 20.27 which is in communication with channel 19.2.

Sealing member 28.21 includes base portion 28.23 and pair of spaced apart beam portions 28.24 extending from base portion 28.23. Pair of finger portions 28.25 extend perpendicularly outward from beam portion 28.24. Sealing member 28.21 further includes seal mounting ledge 28.30 spaced apart from and extending parallel to base portion 28.23. Seal mounting ledge 28.30 includes T-shaped slots 28.27. Seals in the form of polymer member 50 and/or brush wiper 48 are coupled to base portion 28.23 in a manner similar to sealing member assembly 18.1 (FIG. 4). More particularly, polymer member 50 and brush wiper 48 include T-shaped attachment portion 50.1 and 48.1 (FIG. 4) which are received within slots 28.27. Base portion 28.23 cooperates with ledge 28.30 to define cavity 46, which receives second sealing member 28.22. Second sealing member 28.22 includes T-shaped slots 28.29, which are adapted to receive T-shaped attachment portions 50.1 and 48.1 (FIG. 4) of polymer member 50 and brush wiper 48, respectively, to sealing member assembly 18.2 with a second set of seals.

Referring still to FIG. 5, base portion 28.23, beam portions 28.24 and finger portions 28.25 cooperate with one another to define chamber 28.26. Beam portions 28.24 slidably extend though opening 20.27 and into channel 19.2 of frame 20.2. Finger portions 28.25 are disposed within channel 19.2 and cooperate with corresponding rim portions 20.25 to secure sealing member 28.21 to frame 20.2 and to limit the sliding movement of finger portions 28.25 in opening 20.27.

Biasing element 26.2 is at least partially disposed within chamber 28.26 of sealing member 28.21 and includes frame-bias end 26.21 and member-bias end 26.22. Frame-bias end 26.21 is either coupled to or bears against body 20.21, while member-bias end 26.22 is either coupled to or bears against sealing member 28.21. Biasing element 26.2 is adapted to bias sealing members 28.21 and, thus, polymer member 50 and brush wiper 48, away from non-extendable wall 12 and against wall 16. Biasing element 26.2 operates in a manner similar to sealing member assembly 18.1 discussed above (FIG. 4). Biasing element 26.2 is illustrated in FIG. 5 as being a spring. However, as discussed above, biasing element may be any mechanism capable of biasing sealing members 28.21, 28.22 and, thus, polymer member 50 and brush wiper 48 toward and against extendable wall 16 (FIG. 3).

Sealing member assembly 18.2 operates in a manner similar to sealing member assembly 18 (FIG. 3) described above. As extendable wall 16 (FIG. 3) moves in the direction of arrow A₁ (FIG. 3), biasing element 26.2 biases sealing member 28.21 and, therefore, polymer members 50 and/or brush wipers 48 coupled to T-shaped slots 28.27 away from frame 20.2 and against extendable wall 16 (FIG. 3). The biasing force of sealing member 28.21 against wall 16, in turn, biases sealing member 28.22 and, therefore, polymer members 50 and/or brush wipers 48 coupled to T-shaped slots 28.29 against extendable wall 16 (FIG. 3). Polymer members 50 and/or brush wipers 48, when biased against extendable wall 16 (FIG. 3), create a seal between the extension unit 14 (FIG. 1) and the non-extendable wall 12 (FIG. 3).

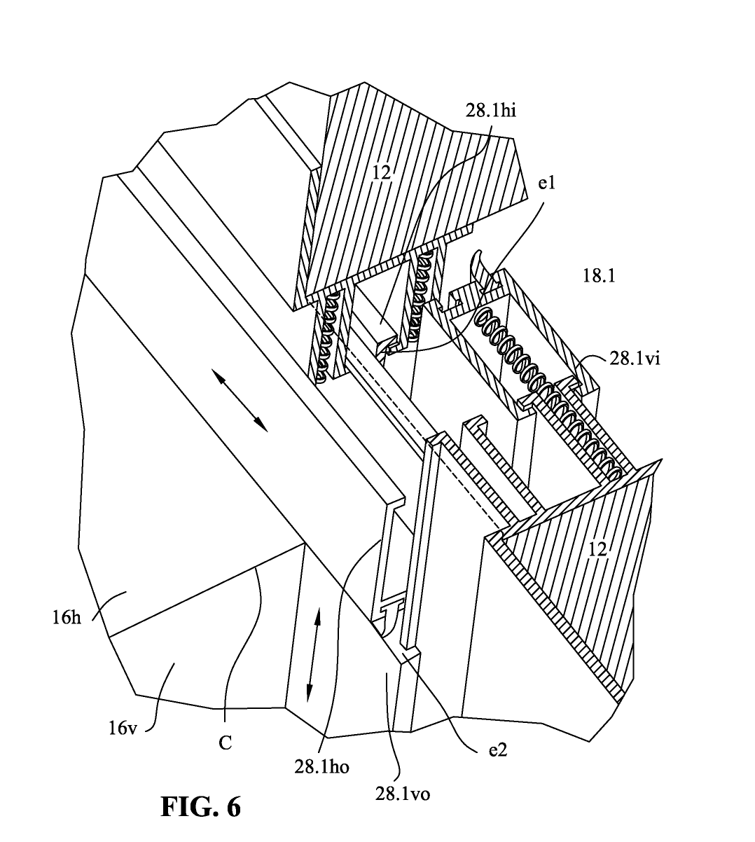

Sealing member assemblies 18, 18.1, and 18.2 provide improved sealing protection in the corners of extension unit 14. For example, FIG. 6 illustrates the corner region of sealing member assembly 18.1. As illustrated in FIG. 6, extendable walls 16 (FIG. 4) includes horizontal wall 16h and vertical wall 16v, which meet at corner C. Sealing member assembly 18.1 includes outer and inner horizontal sealing members 28.1ho, 28.1hi extending horizontally and bearing against horizontal extendable wall 16h. Sealing member assembly 18.1 also includes outer and inner vertical sealing members 28.1vo, 28.1vi extending vertically and bearing against vertical extendable wall 16v. As illustrated in FIG. 6, both inner vertical sealing member 28.1vi and outer horizontal sealing member 28.1ho extend beyond corner C of horizontal and vertical walls 16h, 16v. Inner vertical sealing member 28.1vi extends beyond corner C and overlaps edge e1 of inner horizontal sealing member 28.1hi, while outer horizontal sealing member 28.1ho extends beyond corner C and overlaps edge e2 of outer vertical sealing member 28.1vo. The overlapping arrangement of sealing members 28.1hi, 28.1 ho, 28.1vi and 28.1vo provides an improved seal at corner C and prevents debris from entering the interior space of structure 10 (FIG. 1) at this commonly vulnerable region of extension unit 14.

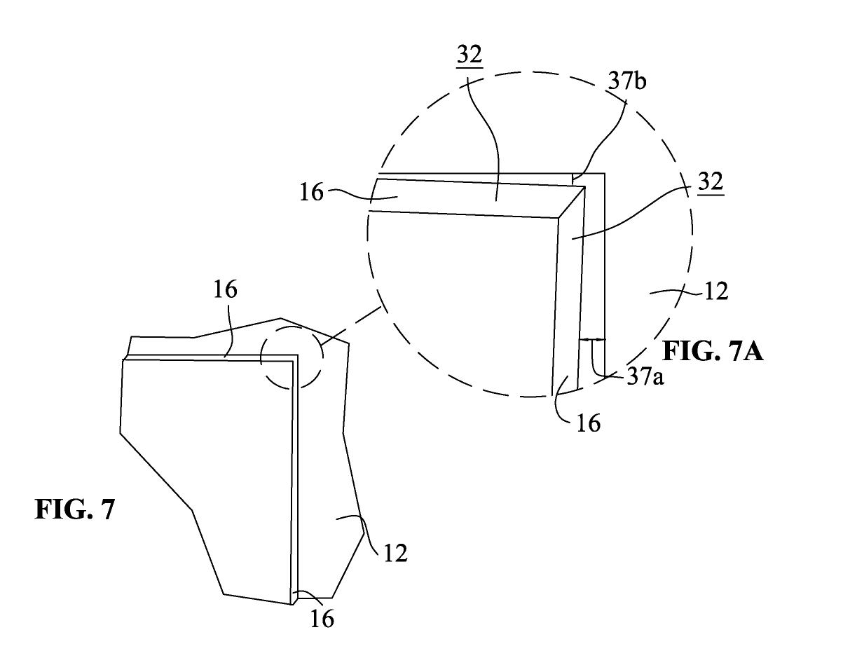

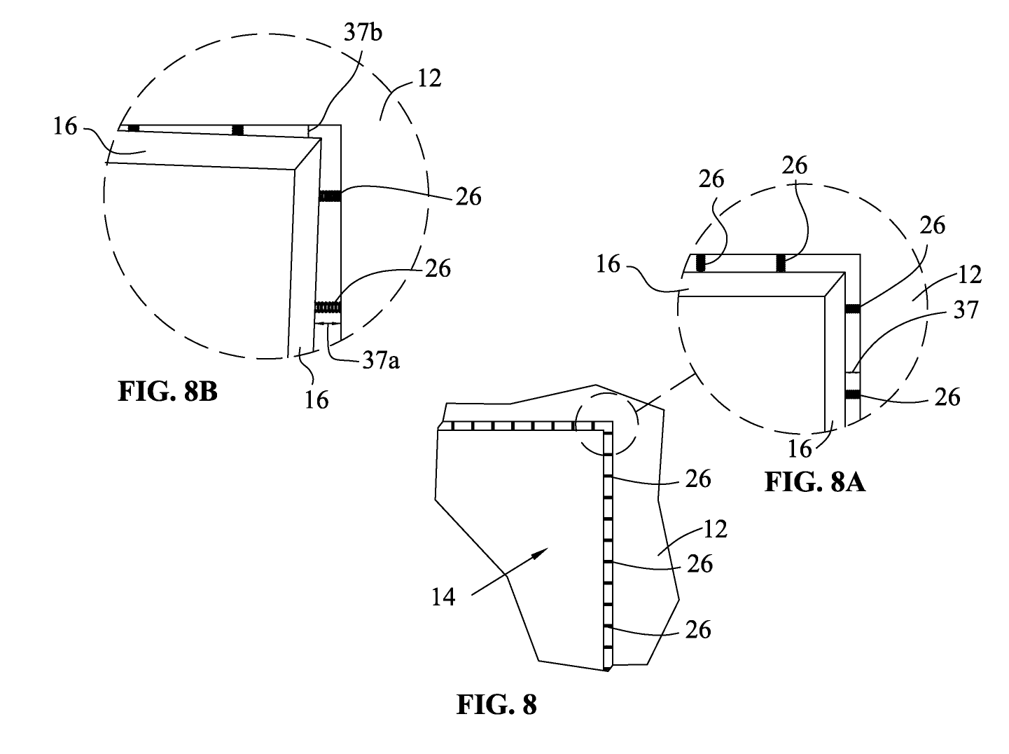

A benefit of using any one of seal assemblies 18,18.1 or 18.2 is shown in FIGS. 7, 7A, 8 and 8A. The distance between the edge of non-extendable walls 12 and extendable side walls 16 defines space 37 therebetween. Ideally, surfaces 16a of extendable side walls 16 extend substantially parallel to the edge of non-extendable walls 12 and remain in this relative arrangement even during the extension and retraction of extension unit 14 (FIG. 1), such that space 37 is consistent extending about the perimeter of extension unit 14 as shown in FIG. 8A. However, as shown in FIGS. 7A and 8B, in some cases extendable walls 16 may become misaligned such that space 37a in one location may deviate in length from space 37b in another location. Even in this case of space deviation, biasing elements 26 continue to provide an adequate seal between walls 12 and walls 16 because the sealing members (not shown) are biased against walls 16 by the biasing members 26, thereby maintaining the seal between extension unit 14 and wall 12. In addition, as shown in FIG. 8 where the seal assembly components 22 and 28 are omitted, biasing members 26 are regularly spaced along the sealing member assembly to provide improved barrier protection and minimize abrading by exerting an even compressive force.

While this invention has been described as having an exemplary design, the present invention may be further modified within the spirit and scope of this disclosure. This application is therefore intended to cover any exemplary embodiments, uses, or adaptations of the invention using its general principles. Further, this application is intended to cover such departures from the present disclosure as come within known or customary practice in the art to which this invention pertains.

What is claimed is:

1. A sealing member assembly for creating a seal between an extendable wall of an extension unit of a structure and a non-extendable wall of the structure, comprising:
a frame configured to attach to the non-extendable wall of the structure;
a first sealing member moveably coupled to said frame; and
a biasing element biasing said first sealing member away from said frame.

2. The sealing member assembly of claim 1, wherein said frame includes a pair of flanges defining a channel therebetween, said first sealing member is slidably coupled to said pair of flanges.

3. The sealing member assembly of claim 2, wherein said first sealing member defines a chamber and includes a pair of spaced apart finger portions, said finger portions defining an opening therebetween, said opening in communication with said chamber, said pair of flanges slidably extending through said opening into said chamber, each of said pair of flanges including a lip, said lip engaging said pair of rim portions to limit the sliding movement of said flanges in said opening.

4. The sealing member assembly of claim 2, wherein said pair of flanges are integrally formed as one unit with said frame.

5. The sealing member assembly of claim 2, wherein said pair of flanges are joined at one end to a connector portion and said frame includes a slit complementary to said connector portion, said projection received in said slit to couple said flanges to said frame.

6. The sealing member assembly of claim 1, wherein said biasing element is a spring.

7. The sealing member assembly of claim 1 further comprising a polymer member, wherein said first sealing member includes a slit and said polymer member includes a projection complementary to said slit, said projection received in said slit.

8. The sealing member assembly of claim 1 further comprising a second sealing member coupled to said frame.

9. The sealing member assembly of claim 1 further comprising a brush seal coupled to said first sealing member.

10. A sealing member assembly configured for use with a structure having non-extendable walls and an extension unit having extendable walls, the sealing member assembly comprising:
a frame configured to be coupled to said non-extendable wall of the structure;
a sealing member coupled to said frame;
a brush wiper seal coupled to said sealing member;
a polymer member coupled to said sealing member; and
wherein said brush wiper and said polymer member are adapted to bear against said extendable walls.

11. The sealing member assembly of claim 10, wherein said sealing member is movably coupled to said frame, such that said sealing member is movable toward and away from said frame, and said sealing member assembly further includes a biasing member operative to bias said sealing member in a direction away from said frame.

12. The sealing member assembly of claim 11, wherein said biasing member is a spring.

13. The sealing member assembly of claim 11, wherein said sealing member defines a chamber, and said frame includes a pair of spaced apart flanges, said pair of flanges are slidably received in said chamber and define a channel therebetween, said channel in communication with said chamber.

14. The sealing member assembly of claim 13, wherein said biasing member is at least partially disposed within said chamber and said channel.

15. The sealing member assembly of claim 10, wherein said polymer member includes a foam interior and a polymer coating layer.

16. A seal assembly for use with a structure having an opening receiving an extension unit, said extension unit formed by a plurality of extendable walls, said opening of said structure defined by at least one horizontal non-extendable wall and at least one vertical non-extendable wall, one of said horizontal non-extendable walls and one of said vertical extendable walls intersecting to form a corner of said opening, the seal assembly comprising:
a pair of vertical sealing members adapted to be coupled to one of said vertical non-extendable walls, each of said pair of vertical sealing members having an end positioned proximal to the corner;
a pair of horizontal sealing members adapted to be coupled to one of said horizontal non-extendable walls, each of said pair of horizontal sealing members having an end positioned proximal to the corner; and
wherein one of said pair of horizontal sealing members extends over said end of one of said pair of vertical sealing members and the other of said pair of vertical sealing members extends over the end of the other of said pair of horizontal sealing members to provide overlapping sealing at the corner.

17. The seal assembly of claim 16, wherein said pairs of horizontal and vertical sealing members are slideably coupled to a frame, said frame adapted to be coupled to the structure and extend about the opening.

18. The seal assembly of claim 17, further comprising a plurality of biasing members each engaging said frame and one of said pairs of vertical and horizontal sealing members, said biasing members operative to bias said vertical and horizontal sealing members away from said frame.

19. The seal assembly of claim 16, wherein each of said pairs of vertical and horizontal sealing members includes a brush wiper seal and a polymer member.

20. The sealing member assembly of claim 19, wherein said polymer member includes a vinyl coated foam.
